(19) United States
(12) Patent Application Publication
(10) Pub. No.: US 2004/0078536 A1
(43) Pub. Date: Apr. 22, 2004

(54) Authentication mechanism integrated with random access memory and method of use

(76) Inventor: Tai-Ming Chen, Los Gatos, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/630,507

(22) Filed: Jul. 28, 2003

Related U.S. Application Data
(60) Provisional application No. 60/420,113, filed on Oct. 22, 2002.

(51) Int. Cl. G06F 12/14

(52) U.S. Cl. 711/164; 713/200

(57) ABSTRACT

A method for authentication in a computer system, includes, while booting the system checking if a memory section is written and if so, allocating the memory section to memory function until finding a memory section that is not written, and then verifying device identification, and if no match is found, halting the system. The method further includes repeat reading to set an incremental input key, and if the key cannot be altered, halting the system. The method finally includes verifying authentication return keys, and if the verify fails, halting the system, while if verification is made, continuing to boot the system.

### RELATED APPLICATIONS

This application claims priority and is entitled to the filing date of U.S. Provisional application Ser. No. 60/420,113 filed Oct. 22, 2002, and entitled “Random Access Memory That Stops Illegal Copy For Computer Or Embedded System.” The contents of the aforementioned application are incorporated by. reference herein.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

The present invention relates to means, in computer processing, for providing security of use, and further to such means in user authentication.

2. Description of Related Art

The following art defines the present state of this field:

Blaner, U.S. Pat. No. 5,737,575 describes memory access latency that is reduced by storage of additional pages of a block together with storage protection keys in a cache memory. When a miss occurs for a particular address and/or a corresponding storage protection key in an address translation look-aside buffer, other storage protection keys for other pages of the same block containing the page causing the miss are associatively accessed from a multi-page key cache. Thus, pages which do not have addresses or storage protection keys stored in the translation look-aside buffer but which are locally stored in a cache may have the storage protection keys provided locally with short access time and without communication over a network.

Hilton et al., U.S. Pat. No. 5,603,008 describes a storage unit for a data processing system including a cache data buffer, a cache tag, and a translation lookaside buffer (TLB). Storage keys are maintained in the TLB with a separate valid bit, which allows a valid translation to be stored upon completion of a translation, even though the key is not yet available. With a valid translation in the TLB entry available, the requesting port is then able to send off a move in request to mainstore right away in parallel with a key request from the translator to the mainstore key array. In the typical case, the key will be returned several cycles ahead of the data, allowing it to be written into the TLB entry and validated in time for the move in data to be successfully bypassed to the requestor as soon as it arrives.

Draves, U.S. Pat. No. 5,802,590 describes a method and system for allowing processes to access resources. A kernel of an operating system maintains a system-wide resource table. This resource table contains resource entries. When a resource is allocated, the kernel generates a key for the resource. The key is a very large number so as to prevent a malicious process from gaining unauthorized access to the resource. The kernel also hashes the key to generate an index into the resource table that is used as a handle. The kernel stores the key in a resource entry that is indexed by the handle. The handle.backslash.key pair is sent to a process. The process accesses the resources by passing handle.backslash.key pairs to the kernel. The kernel compares the passed key with a key that is stored in the resource entry. referenced by the passed handle. When the stored key and the passed key match, the process is allowed to access the resource. When the stored key and the passed key do not match, the kernel rehashes the passed key to generate a new handle. The kernel then searches starting at the index of the new handle for a resource entry with a key that matches the passed key. When a key matches the passed key, the process is allowed to access the resource, and the index for the resource entry is returned to the process so that the process can use the index as a handle to access the resource on subsequent resource access requests. When the passed key does not match a key, the process is denied access to the resource.

Yoshimura, U.S. Pat. No. 5,933,854 describes a system wherein a memory card that is connected to a computer, data stored in a memory device in the memory card is read by a processor provided in the computer. An address signal and a data signal from the computer to the memory card, and/or a data signal from the memory card to the computer are coded with coding keys by a coder, while the coded signal is decoded by a decoder with a decoding key corresponding to the coding keys. The coder and the decoder adopts a public key system, and it is difficult to determine the decoding key even if the coding keys are known. In modified examples, coding keys are not provided beforehand in the computer or memory card, and they are latched in a latch device when the memory card is connected to the computer. When the coding keys and decoding keys are stored in the memory card, they are changed for each memory card.

Ullum et al., U.S. Pat. No. 6,266,705 describes an improved look up mechanism for accessing a RAM to obtain forwarding information for data frames being transported among ports of a high-performance switch. The look up mechanism includes a multi-page look up table and associated hashing technique. A media access control (MAC) address and a virtual local area network (VLAN) identifier are transformed with a hash function to obtain a hash key. The hash key is an address pointing to a particular entry in the look up table. A virtual first page is also derived from the hash key, which selects a particular physical page of the look up table to be initially accessed each time that MAC address/VLAN pair is used. The look up mechanism may also be used to access a short cut table containing Layer 3 short cut information. In either case, ultimately, the likelihood is increased that a match will be found on the first RAM access, thus maintaining high-speed switch performance.

Biran, U.S. Pat. No. 6,345,347 describes a computer system in which a software application accesses a system memory by communicating directly with a hardware device, a method for protecting addresses in the memory from improper access. The method includes, in an initialization stage, assigning a register of the hardware device to the application and generating in the hardware device a protection block, which block is used thereafter by the device to control access by the application to the system memory. A first key is stored in the protection block corresponding to a physical address of the register, and a handle is assigned to the application that refers to the protection block. In operation of the application, a command is conveyed from the application via the register to access the system memory, the command including the handle. Responsive to the command, a second key is generated in the hardware device corresponding to the physical address of the register. Responsive to the handle, the first and second keys are compared, and the application is allowed to access the memory only if the keys match in a predetermined manner.

Diede et al., U.S. Pat. No. 6,370,613 describes a CAM system for determining which data word in a CAM array exhibits the longest continuous, unmasked match with an input data value. The input data value is divided into non-overlapping subfields, thereby creating a series of keys, the first key of the series including either the least significant bit (LSB) or most significant bit (MSB) of the input data value. The CAM array is divided along columns into a similar series of non-overlapping sub-arrays corresponding to the subfields defined by the series of keys. A first CAM sub-array compares the first key with its stored rows of data bit values to generate a first match signal. The first match signal disables each row of the second CAM sub-array for which the corresponding row of the first CAM sub-array did not show a match. A second CAM sub-array then compares the second key with its enabled rows to generate a second match signal. The second match signal disables each row of the third CAM sub-array for which the corresponding row of either the first or second CAM sub-array did not show a match. This comparison process continues in sequence with the remaining keys and CAM sub-arrays. The row of the CAM array that shows a match over the most consecutive comparison operations contains the longest match for the input data value. If multiple rows match over the same number of comparison operations, a priority encoder determines which location has the highest priority.

Greene et al., U.S. Pat. No. 6,434,662 describes a system and method form searching an associative memory using input key values and first and second hashing sections. Key values (Kn) can be hashed in the first hashing section (102) to generate first output values H.sub.1 (Kn) that access a first store (104). The first store or memory portion (104) can include “leaf” pointer entries (106-2) and “chunk pointer” entries (106-3). A leaf pointer entry (106-2) points at data associated with an applied key value. A chunk pointer entry (106-3) includes pointer data. If a chunk pointer entry (106-3) is accessed, the key-value (Kn) is hashed in the second hashing section (108) to generate second output values H.sub.2 (Kn) that access a second store or memory portion (110). Second hashing section (108) hashes key values (Kn) according to selection data SEL stored in a chunk pointer entry (106-3). The system may also include a first memory portion accessed according to address values from the first hashing section and a second memory portion accessed according to address values that include outputs from the second hash section and a chunk base address value. The hash based associative system allows for the selection of a second hash function that has been precomputed at table build time to be perfect with respect to a small set of colliding key values, provides a deterministic search time independent of the number of table entries or width of the search key, and allows for pipelining to achieve highest search throughput.

Melchior, U.S. Pat. No. 6,473,846 describes a content. addressable memory (“CAM”) engine or controller interfacing between a host signal processor (e.g., a microprocessor) and a plurality of known, commercially-available random access memory (“RAM”) devices. The CAM engine configures the RAM as content addressable memory, thereby causing the normally location-addressed RAM to function as CAM. The CAM engine thus allows for the benefits of both RAM and CAM devices, such as speed, density, cost and intuitiveness, without their inherent drawbacks. Further, the CAM engine implements various flexible memory storage configurations for the keys and associations stored in RAM. Also, the CAM engine implements certain algorithms that provide for the hashing of data, for table load and unload capabilities, for proximity matching, for dealing with overflow conditions, and for implementing hierarchical search capabilities.

Adams et al., U.S. Pat. No. 6,487,646 describes a data storage device capable of restricting access to data storage or retrieval when a first code is incompatible with a second code. The data storage device comprises (a) a data storage media having a data storage region; and (b) a controller adapted to compare a first code with a second code and to restrict access to a portion of the data storage region of the data storage device if the first code is incompatible with the second code.

Ikeda, U.S. Pat. No. 6,490,667 describes a base board on which wiring is provided, a memory, installed on the base board by soldering, for storing data and a certification key, and a memory control LSI. The memory control LSI is a fabricated as a bare chip incorporating an internal memory for storing data and a certification key, and a control section for controlling the storing of data in the memory and the reproduction of the data from the memory. The bare chip is installed on the base board and covered with sealing resin. The bare chip is connected to the base board by gold wire bonding. The certification key stored in the memory is compared with the certification key stored in the internal memory. Based on the coincidence or non-coincidence between these keys, the control section determines whether or not the memory is an intended one.

Barret et al., U.S. Ser. No. 2002/0083283 describes A method and a circuit for controlling the access to all or part of the content of a first memory integrating with a microprocessor, consisting of using a priority-holding interrupt, of using at least one register of keys, and of applying at least one access control algorithm contained in a second auxiliary memory and using the content of at least one also integrated storage element and the content of the key register, the content of the auxiliary memory being programmable only once.

Ikegai et al., U.S. Ser. No. 2002/0152352 describes an information retrieval system including two content addressable memories to be searched for m-bit/n-bit codes identical with m-bit/n-bit retrieval key sub-codes, a data memory storing pieces of information relating to different retrieval keys expressed by the combinations of the m-bit/n-bit codes in addressable memory locations assigned addresses, respectively, and an address generating unit supplied with addresses of the m-bit/n-bit codes identical with the m-bit/n-bit retrieval key sub-codes from the content addressable memories so as to generate a target address from the addresses for accessing the piece of information relating to a given retrieval key, whereby the two content addressable memories are searched for the m-bit/n-bit codes substantially in parallel.

The prior art teaches an interleaved key memory with multi-page key cache, a computer system having cache memories with independently validated keys in the TLB, a method and system for providing secure access to computer resources; a data security system for transmitting and receiving data between a memory card and a computer using a public key cryptosystem, a look up mechanism and associated hash table for a network switch, an address protection using a hardware-defined application key, a content addressable memory with longest match detect, a system and method for searching an associative memory utilizing first and second hash functions, a content addressable memory engine, an apparatus and method capable of restricting access to a data storage device, a portable electronic medium, a means for control of the access to a memory integrated with a microprocessor, and a high speed information retrieval system. The prior art, however, does not teach the use of RAM device cells for placement of authentication keys, nor a method of utilization thereof. The present invention fulfills these needs and provides further related advantages as described in the following summary.

### SUMMARY OF THE INVENTION

The present invention teaches certain benefits in construction and use which give rise to the objectives described below.

Because in embedded systems such as consumer electronic devices, every hardware component is exposed, these systems are vulnerable to illegal duplication including the manufacture of pirate copies. It is therefore desirable to provide an authentication mechanism in such systems. However, because of added cost and interface compatibility issues, authentication mechanisms have not been well accepted.

In the present invention, the authentication mechanism is integrated into a random access memory (RAM) device, which is most frequently used with embedded systems. To make this approach acceptable by lowering cost, the authentication mechanism shares the hardware interface of the RAM device and also utilizes the undefined state of the RAM device after it has been reset. For most RAM devices such as a static RAM (SRAM) device or a dynamic RAM (DRAM) device, memory content is undefined when no write operation takes place. Thus, the content of a RAM device may be any value, although current RAM device products define the unwritten memory as all zeros or all OxFF, this cannot be trusted. A RAM device memory location should be written prior to reading it, otherwise, the state of the memory location must be considered unknown.

One objective of the present invention is to utilize the undefined read operations in performing an authentication process. As stated, performing a read operation before a value is written returns an undefined value on conventional RAM devices. Instead of returning undefined values in the RAM device of the present invention, authentication keys are returned during an authentication check. The system central processor unit (CPU) uses these keys to perform an authentication check. Unless the keys are a match the CPU aborts the program and comes to a halt state leaving the system useless. The authentication keys function to match a set of secret keys programmed into the system's code at the time of the consumer electronic device's manufacture. Once programmed the secret keys cannot be retrieved by any means whatsoever, so as to overcome the device's protection. Therefore, although the hardware and the computer program residing in read-only memory (ROM) may be exactly duplicated by a pirate, without the ability to gain access to the authentication keys, such duplication is not of value since the system will not operate.

A primary objective of the present invention is to provide an apparatus and method of use of such apparatus that provides advantages not taught by the prior art.

Another objective is to provide such an invention capable of authentication upon each boot-up.

A further objective is to provide such an invention capable of avoiding reverse engineering discovery of key secret authentication codes.

A still further objective is to provide such an invention capable of using a random generator to prevent system startup without knowledge of the startup authentication codes.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a block diagram of the preferred embodiment of the invention;

FIG. 2 is a pin-out diagram of a RAM device thereof;

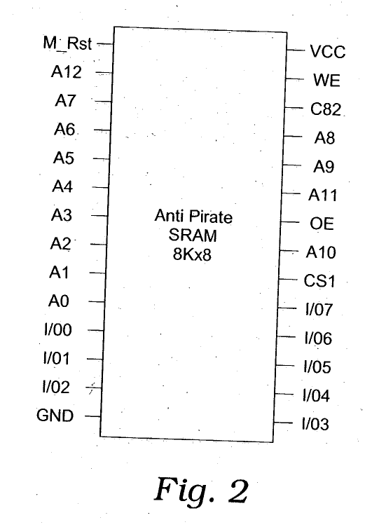

FIG. 3 is a diagram showing memory sections thereof;

FIG. 4 is a sector map thereof, and

FIG. 5 is a logic flow diagram of the method thereof.

### DETAILED DESCRIPTION OF THE INVENTION

The above described drawing figures illustrate the invention in at least one of its preferred embodiments, which is further defined in detail in the following description.

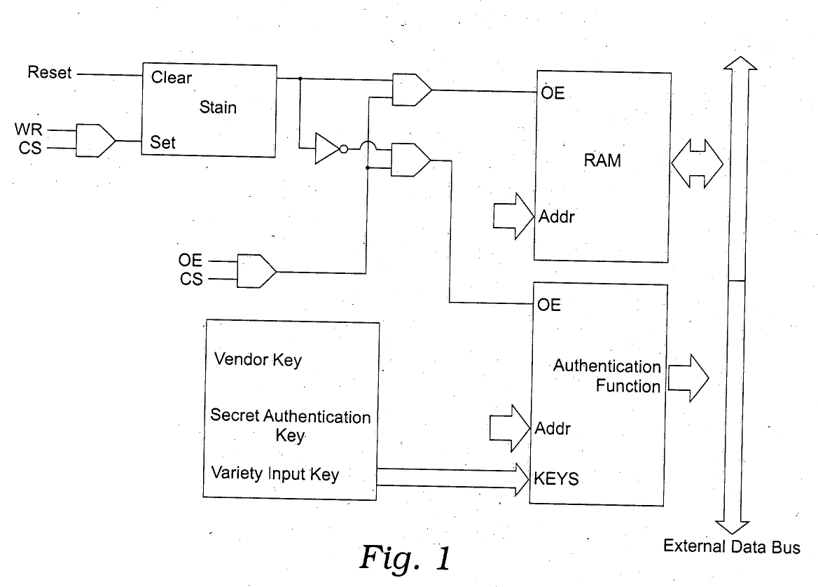

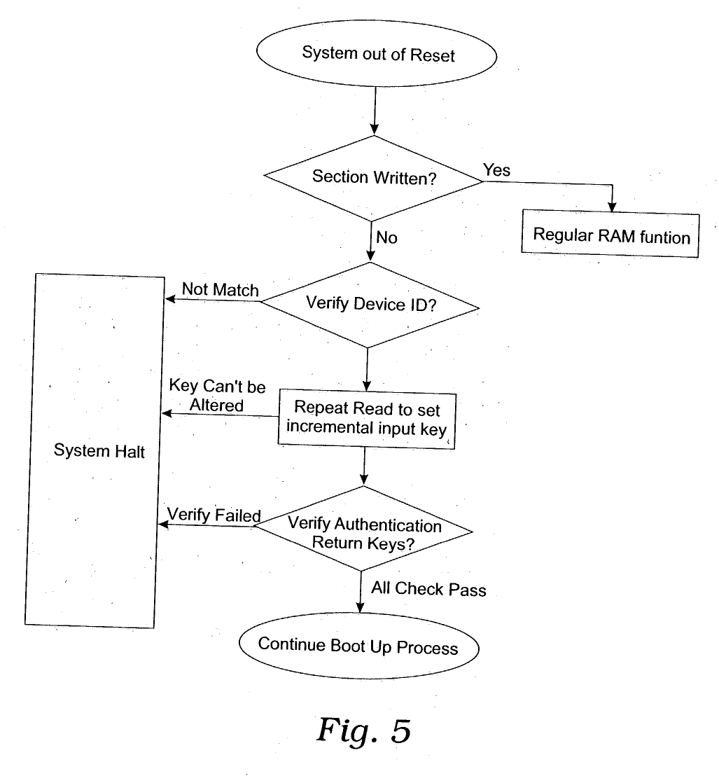

Memory devices used in computer circuits usually have a large number of memory cells. These cells are organized into words with each of the words having an assigned address. Thus, individual words may be retrieved by selecting an address. In the present invention, (FIG. 1) a CPU executes an authentication check program (FIG. 5) and uses certain memory locations to do so. A portion of RAM is used for memory functions, as is well known in the art, while another portion, in the present invention, is used to provide authentication keys for the authentication check program. This dual use forms the basis of the present invention and it will be described below how such use is enabled and how it operates.

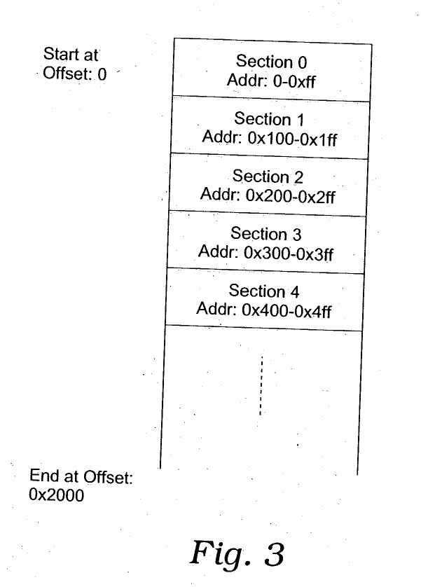

In order to perform both function at a same time, advantage is made of the fact that a memory device is divided into sections. See FIG. 3. After system reset or boot-up, all memory sections are in default mode and are therefore able to provide interface for authentication function. Any section needed by CPU for memory function can be switched back to memory function by simply issuing a write operation to it, as is well known. The write operation brings the selected section into memory function while leaving unwritten sections to keep serving the authentication function. Once authentication is complete, all sections may be used for memory function including those previously used for authentication accesses. For instance, an 8 k×8 memory piece has 8096 memory addresses for storing as many words. Each word has eight bits. Each memory piece may be divided into 32 sections as in our example; with each section having 256 bytes. This is only one possible example of memory partitioning, and serves to illustrate the principals of the present invention.

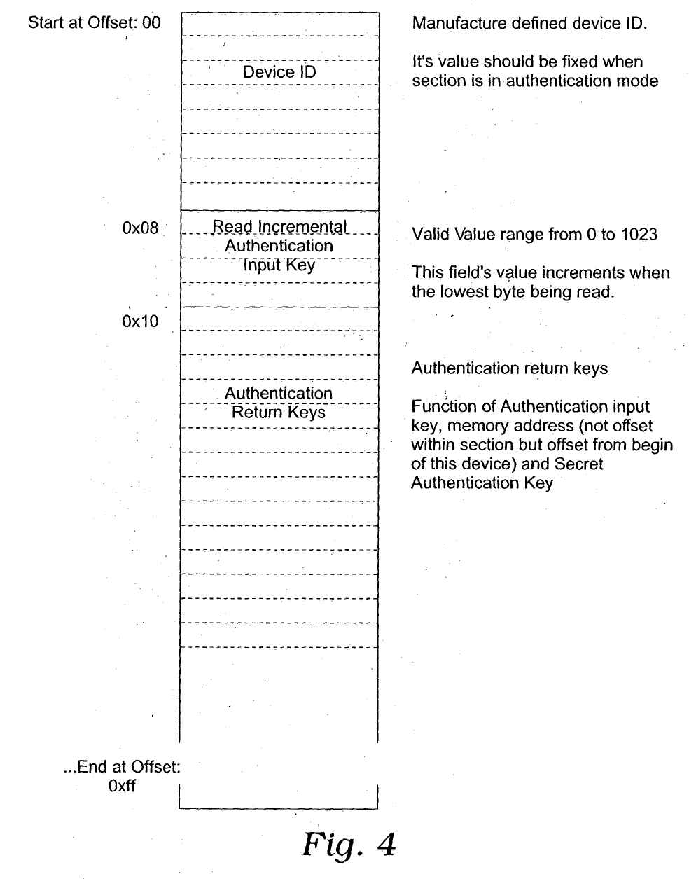

When the computer system boots-up it only requires one section of memory space to serve the authentication function and will be able to use up to 31 sections of memory addressing space for memory functions. A single section provides space for 256 bytes for the authentication function. These addresses or locations are used to provide device identification, read incremental input key and authentication return keys, as FIG. 4 shows. The first eight bytes of each section are used to provide device identification. Part of this identification is a fixed value as long as a section is serving the authentication function. This typically defines vender and product. The authentication program reads a first field to ensure that this section is serving the correct function. If its value doesn't match the identification code it is determined that the section identifies the wrong device or the section is not used for the authentication function and therefore may be used for the memory function. The second field is a read incremental authentication input key. Contents of this field increments every time it is read. The CPU sets this field's value by reading it a specified number of times. Its value is referred to calculate the values of the authentication keys. If an attempt to defeat the system is made by placing a copy of known authentication keys in memory, this field obsoletes them. Since this fields value increments each time it is read, the program can read this field a random number of times prior to accessing the rest of the authentication keys, therefore the authentication keys are not fixed and will be only decided on run time. Using a read incremental counter to set a value may require many access cycles, yet its advantage includes avoiding any write operation which brings a section out of authentication mode and into memory mode. Therefore, it is necessary to limit the number of bits in the field. If 10 bits are used, for example, any desired value can be reached within 1024 accesses of the counter. Since this field plays a part in generating authentication keys, a pirate copier can't predict which value out of 1024 the CPU is going to set for this field, assuming a true random number is used, there is no way to predict an image of authentication keys to pass the check.

As FIG. 4 shows, the remainder of the authentication section is used to provide authentication return keys. These authentication return keys are a function of a few combinational inputs and are a product of specific secret authentication key an authentication input key and an access address. The access address is the address within the memory element, i.e., RAM. Each location has a unique address. Each authentication input key is determined by the read incremental counter as described above. The value at the last time this field was read is used as an authentication input key. The secret authentication key distinguishes one authentication check from the others. There can be more than one product using this same authentication device, as long as they are pre-programmed with different secret keys, the return authentication keys will not be the same. Hence a device used by one product can't be interchangeable within a different type of product. Due to its secret nature, no one knows another system's secret keys, therefore there is no way to avoid choosing the same secret key. If that happen, it's a collision between two secret keys. To minimize the possibility of key collision, a long secret code is selected, as for instance 32 bits, 64 bits or 128 bits. A simple combination for the secret key such as all 0 or all 1's should be avoided. The secret key is pre-programmed into the device prior to its use in a system. Once it is programmed, there is no way to retrieve it, even by the designer. The only method to verify that the secret key has been correctly programmed is to perform an authentication check.

The secret key must be hard to trace back through reverse engineering. While return keys must have enough variety such that two devices with different secret keys will not have an identical return key set, so they are not interchangeable. Individual functions like bit scramble, exclusive-OR and modulation are usually good sub-function candidates for these functions.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A method for authentication in a computer system, the method comprising the steps of: bringing the computer system out of reset; checking if a memory section is written and if so, allocating the memory section to memory function; verifying device identification if the memory section is not written, and if no match is found, halt the system; repeat read to set an incremental input key, and if the key cannot be altered, halt the system; verify authentication return keys, and if the verify fails, halt the system; and continue to bring the computer system out of reset.

2. The method of claim 1 further comprising the step of reading of incremental authentication input keys and authentication return keys.

3. The method of claim 1 further comprising the step of using the first eight bytes of each memory section to provide device identification.

4. The method of claim 3 further comprising the step of using part of the identification as a fixed value as long as a section is serving the authentication function.

5. The method of claim 1 further comprising the step of reading a first field of each section to ensure that the section is serving the authentication function.

6. The method of claim 1 further comprising the step of reading a second field as an incremental authentication input key.

7. The method of claim 6 further comprising the step of incrementing the contents of the second field every time it is read.

8. The method of claim 7 further comprising the step enabling the CPU to set the value of the second field by reading it a specified number of times.

9. The method of claim 8 further comprising the step using the value of the second field to calculate values of the authentication keys.

10. The method of claim 1 further comprising the step of obsolescing the authentication keys when an attempt to defeat the system is made by placing a copy of known authentication keys in memory.

11. In a computer system, a random access memory device comprising: a plurality of memory cells arranged in sections, including a first section containing a manufacturer identification fixed when the computer system is in an authentication mode; a second read incremental section incrementing at each read of a central processor unit of the computer system; and an authentication return keys third section including a secret authentication key.
